(19) United States
(12) Patent Application Publication
(10) Pub. No.: US 2024/0412100 A1
(43) Pub. Date: Dec. 12, 2024

(54) SYSTEM AND METHOD FOR DETERMINATION AND CLASSIFICATION OF PERSONAL IDENTIFIABLE INFORMATION IN A FILE

(71) Applicant: Securiti, Inc., San Jose, CA (US)

(72) Inventors: Xiaolin Wang, San Jose, CA (US); Michael Rinehart, San Jose, CA (US)

(21) Appl. No.: 18/331,979

(22) Filed: Jun. 9, 2023

(51) Int. Cl. G06N 20/00; G06F 40/279

(52) U.S. Cl. CPC G06N 20/00; G06F 40/279

(57) ABSTRACT

A system for determination and classification of personal identifiable information in a file using machine learning is disclosed. The system includes a processing subsystem which includes a pre-processing module and a machine learning module. The preprocessing module receives a data source including a plurality of structured data, a plurality of semi-structured data, and a plurality of unstructured data from a web page, converting the data source into a machine-readable format. The machine learning module includes a feature detection module detecting personal identifiable information features from a group of a plurality of groups, a feature extraction module extracts the plurality of personal identifiable information features from the group of at least one of a static list and a stream. The context recognition module contemplates a plurality of data source-specific features to recognize the context of personal identifiable information. The classification module predicts the presence of personally identifiable information.

### FIELD OF INVENTION

Embodiments of a present disclosure relate to electronic text processing and more particularly a system and a method for the determination and classification of personal identifiable information in a file.

### BACKGROUND

A digital file is a file that is structured as a sequence of lines of electronic data. The file is processed for better functioning and for better use of the processed data. File processing includes manipulating, extracting, converting, featurizing, and classifying data. Typically, data processing begins with the process of data determination wherein relevant data is identified. Further, a featurizer (a chunk of code) is used to transform raw input data into a processed form suitable for machine learning. Data classification is the process of organizing data into categories that make it easy to retrieve, sort, and store for future use. Data classification is helpful in data privacy in the case of the classification of personal data, or confidential data.

With the rise of privacy regulations such as general data protection regulation among others, enterprises need to be able to shift through large corpuses of documents and to identify the documents including personally identifiable information (PII). As the number of files to process (without automation) increases, the automation around discovering documents containing PII is challenging. The currently existing systems do not provide accuracy at the PII classification level. Also, for growing personal data (PD) types, the rule based PII detection system needs to keep adding rules for them. The currently existing system does rely on humans to read documents to inspect the presence of PII.

There is a need for a system to solve the accuracy problem by applying machine learning algorithms and to determine whether PII is present within a document. Also, there is a need for a system that addresses the growing PD types of problems. Further, there is a need for a system that solves a scalability problem while manipulating the data.

Hence, there is a need for a system and a method for the determination and classification of personal identifiable information in a file that addresses the aforementioned issues.

### OBJECTIVE OF THE INVENTION

An objective of the present invention is to determine and classify personally identifiable information in a file.

Another objective of the present invention is to provide accuracy in determination and classification of personally identifiable information by using a machine learning technique.

Yet, another objective of the present invention is to solve a scalability problem while manipulating data.

Further, an objective of the present invention is to provide automation in processing a large number of files.

### BRIEF DESCRIPTION

In accordance with an embodiment of the present disclosure, a system for determination and classification of personal identifiable information in a file using machine learning is provided. The system includes a processing subsystem hosted on a server and configured to execute on a network to control bidirectional communications among a plurality of modules. The plurality of modules includes a pre-processing module and a machine learning module. The preprocessing module is configured to receive a data source including a plurality of structured data from a web page, a plurality of semi-structured data, and a plurality of unstructured data. The data source includes a set of information with personal identifiable information. The preprocessing module is also configured to convert the data source into a machine-readable format. The machine learning module is operatively connected to the preprocessing module. The machine learning module includes a feature detection module, a feature extraction module, a context recognition module, and a classification module. The feature detection module is configured to detect personal identifiable information features from a group of a plurality of groups, wherein the plurality of groups includes a plurality of personal identifiable information. The feature extraction module is operatively connected to the feature detection module. The feature extraction module is configured to extract the plurality of personal identifiable information features from the group of at least one of a static list and a stream. The static list is obtained in response to scanning the data source and wherein the stream is generated dynamically in response to the scanning the data source. The feature extraction module is also configured to featurize each group of the personally identifiable information located in the web page after scanning of the data source. The context recognition module is operatively connected to the feature extraction module and configured to contemplate a plurality of data source-specific features to recognize the context of the personally identifiable information in case of the unstructured data. The plurality of data source-specific features includes at least one of visual feature, text feature, per token representations, features indication for consideration of the token as personally identifiable information, and a type of the personally identifiable information. The classification module is operatively connected to the feature extraction module. The classification module is configured to receive the extracted plurality of personally identifiable information features. The classification module is also configured to predict the presence of personally identifiable information in the data source. Further, the classification module is configured to group the personally identifiable information predicted on the web page and predict the presence of the personally identifiable information in an event of the unstructured data source, wherein the grouping is repeated for all the web pages.

In accordance with an embodiment of the present disclosure, a method for determining and classifying personally identifiable information in a file is provided. The method includes receiving, by a preprocessing module of a processing subsystem, a data source comprising a plurality of structured data from a web page, a plurality of semi-structured data, and a plurality of unstructured data, wherein the data source includes a set of information along with personally identifiable information. The method also includes converting, by the preprocessing module of the processing subsystem, the data source into a machine-readable format. Further, the method includes detecting, by a future detection module of a machine learning module, personally identifiable information features from a plurality of groups, wherein the plurality of groups includes a plurality of personally identifiable information. extracting, by a feature extraction module of the machine learning module, the plurality of personally identifiable information features from the group of at least one of a static list and a stream, wherein the static list is obtained in response to scanning the data source and wherein the stream is generated dynamically in response to the scanning the data source. Furthermore, the method includes featurizing, by a feature extraction module of the machine learning module, each group of the personal identifiable information located on the web page after scanning of the data source. Furthermore, the method includes contemplating, by a context recognition module of the processing subsystem, a plurality of data source-specific features to recognize the context of the personal identifiable information in case of the unstructured data., wherein the plurality of data source-specific features comprises at least one of a visual feature, text feature, per token representations, features indication for consideration of the token as personal identifiable information, and a type of the personal identifiable information. Furthermore, the method includes receiving, by a classification module of the processing subsystem, the extracted plurality of personal identifiable information features. Furthermore, the method includes predicting, by the classification module of the processing subsystem, the presence of personally identifiable information in the data source. Furthermore, the method includes grouping, by the classification module of the processing subsystem, the personal identifiable information predicted on the web page and predict the presence of the personally identifiable information in an event of the unstructured data source.

In accordance with an embodiment of the present disclosure, a non-transitory computer-readable medium storing a computer program that, when executed by a processor, causes the processor to perform a method for the determination and classification of personal identifiable information in a file using machine learning is provided. The method includes receiving, by a preprocessing module of a processing subsystem, a data source comprising a plurality of structured data from a web page, a plurality of semi-structured data, and a plurality of unstructured data, wherein the data source includes a set of information along with personal identifiable information. The method also includes converting, by the preprocessing module of the processing subsystem, the data source into a machine-readable format. Further, the method includes detecting, by a future detection module of a machine learning module, personal identifiable information features from a group of a plurality of groups, wherein the plurality of groups includes a plurality of personal identifiable information. extracting, by a feature extraction module of the machine learning module, the plurality of personal identifiable information features from the group of at least one of a static list and a stream, wherein the static list is obtained in response to scanning the data source and wherein the stream is generated dynamically in response to the scanning the data source. Furthermore, the method includes featurizing, by a feature extraction module of the machine learning module, each group of the personal identifiable information located on the web page after scanning of the data source. Furthermore, the method includes contemplating, by a context recognition module of the processing subsystem, a plurality of data source-specific features to recognize the context of the personal identifiable information in case of the unstructured data., wherein the plurality of data source-specific features includes at least one of a visual feature, text feature, per token representations, features indication for consideration of the token as personal identifiable information, and a type of the personal identifiable information. Furthermore, the method includes receiving, by a classification module of the processing subsystem, the extracted plurality of personal identifiable information features. Furthermore, the method includes predicting, by the classification module of the processing subsystem, the presence of personally identifiable information in the data source. Furthermore, the method includes grouping, by the classification module of the processing subsystem, the personal identifiable information predicted on the web page and predict the presence of the personally identifiable information in an event of the unstructured data source.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for determination and classification of personal identifiable information in a file in accordance with an embodiment of the present disclosure;

FIG. 2 is a block diagram representation of a machine learning module of FIG. 1 in accordance with an embodiment of the present disclosure;

FIG. 3 is an exemplary embodiment of the representation of an unstructured data form of FIG. 1 in accordance with an embodiment of the present disclosure;

FIG. 4 is an exemplary embodiment of the representation of an unstructured natural text data of the data source file of FIG. 1 in accordance with an embodiment of the present disclosure;

FIG. 5 is a block diagram of a computer or a server in accordance with an embodiment of the present disclosure;

FIG. 6(a) illustrates a flow chart representing the steps involved in a method for the determination and classification of personally identifiable information in a file in accordance with an embodiment of the present disclosure; and

FIG. 6(b) illustrates the continued steps of the method for the determination and classification of personally identifiable information in a file of FIG. 6(a) in accordance with an embodiment of the present disclosure.

Further, those skilled in the art will appreciate that elements in the figures are illustrated or simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for determination and classification of personal identifiable information in a file using machine learning is provided. The system includes a processing subsystem hosted on a server and configured to execute on a network to control bidirectional communications among a plurality of modules. The plurality of modules includes a pre-processing module and a machine learning module. The preprocessing module is configured to receive a data source including a plurality of structured data from a web page, a plurality of semi-structured data, and a plurality of unstructured data. The data source includes a set of information with personal identifiable information. The preprocessing module is also configured to convert the data source into a machine-readable format. The machine learning module is operatively connected to the preprocessing module. The machine learning module includes a feature detection module, a feature extraction module, a context recognition module, and a classification module. The feature detection module is configured to detect personal identifiable information features from a group of a plurality of groups, wherein the plurality of groups comprises a plurality of personal identifiable information. The feature extraction module is operatively connected to the feature detection module. The feature extraction module is configured to extract the plurality of personal identifiable information features from the group of at least one of a static list and a stream. The static list is obtained in response to scanning the data source and wherein the stream is generated dynamically in response to the scanning the data source. The feature extraction module is also configured to featurize each group of the personal identifiable information located in the web page after scanning of the data source. The context recognition module is operatively connected to the feature extraction module and configured to contemplate a plurality of data source-specific features to recognize the context of the personal identifiable information in case of unstructured data. The plurality of data source-specific features comprises at least one of a visual feature, text feature, per token representations, features indication for consideration of the token as personal identifiable information, and a type of personal identifiable information. The classification module is operatively connected to the feature extraction module. The classification module is configured to receive the extracted plurality of personal identifiable information features. The classification module is also configured to predict the presence of personally identifiable information in the data source. Further, the classification module is configured to group the personal identifiable information predicted on the web page and predict the presence of the personally identifiable information in an event of the unstructured data source, wherein the grouping is repeated for all the web pages.

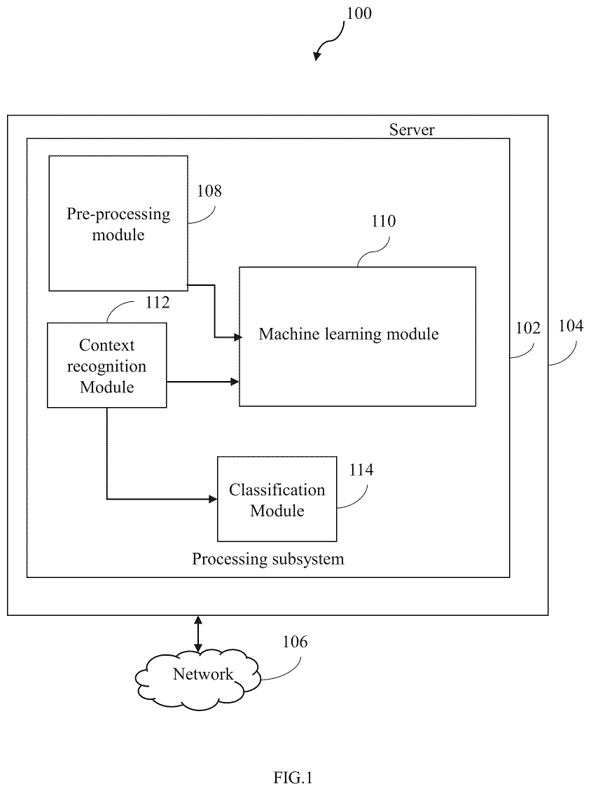

FIG. 1 is a block diagram representation of a system 100 for determination and classification of personally identifiable information in a file in accordance with an embodiment of the present disclosure. The system 100 includes a processing subsystem 102 hosted on a server 104 and configured to execute on a network 106 to control bidirectional communications among a plurality of modules. In one embodiment, the network 106 may include one or more terrestrial and/or satellite networks interconnected to communicatively connect a user device to web server engine and a web crawler. In one example, the network 106 may be a private or public local area network (LAN) or wide area network, such as the Internet.

Moreover, in another embodiment, network 106 may include both wired and wireless communications according to one or more standards and/or via one or more transport mediums. In one example, the network 106 may include wireless communications or Bluetooth specification sets, LoRa (Long Range Radio), or another standard or proprietary wireless communication protocol. In yet another embodiment, the network 106 may also include communications over a terrestrial cellular network, including, a GSM (global system for mobile communications), CDMA (code division multiple access), and/or EDGE (enhanced data for global evolution) network.

The plurality of modules of the processing subsystem 102 includes a pre-processing module 108, a machine learning module 110, a context recognition module 112, and a classification module 114. The preprocessing module 108 is configured to receive a data source comprising a plurality of structured data from a web page, a plurality of semi-structured data, and a plurality of unstructured data. Specifically, the data source includes a set of information with personally identifiable information. The preprocessing module 108 is configured to convert the data source into a machine-readable format.

The machine learning module 110 is operatively connected to the preprocessing module 108. The machine learning module 110 includes one or more machine learning techniques which may include, but are not limited to, linear regression, logistic regression, decision tree, SVM technique, naive Bayes technique, KNN technique, K-means, random forest technique, and the like.

The context recognition module 112 is operatively connected to the machine learning module 110. The context recognition module 112 is configured to contemplate a plurality of data source-specific features to recognize the context of the personal identifiable information in case of the unstructured data. The plurality of data source-specific features includes at least one of a visual feature, text feature, per token representations, features indication for consideration of the token as personal identifiable information, and a type of the personal identifiable information.

The classification module 114 is operatively connected to the machine learning module 110. The classification module 114 is configured to receive the extracted plurality of personal identifiable information features. The classification module 114 is also configured to predict the presence of personally identifiable information in the data source. Further, the classification module 114 is configured to group the personal identifiable information predicted on the web page and predict the presence of the personally identifiable information in an event of the unstructured data source. The grouping is repeated for all the web pages.

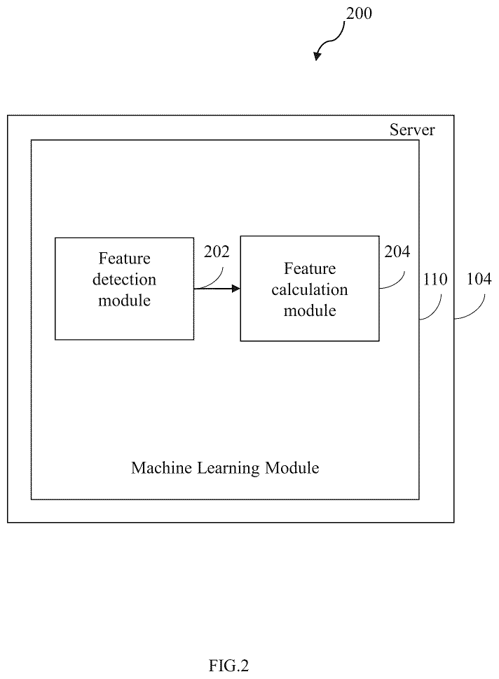

FIG. 2 is a block diagram representation of a machine learning module 110 of FIG. 1 in accordance with an embodiment of the present disclosure. Typically, the machine learning module 110 is trained by machine learning techniques/algorithms. The machine learning module 110 further includes a feature detection module 202 and a feature extraction module 204.

. The feature detection module 202 is configured to detect personally identifiable information features from a plurality of groups. The plurality of groups includes a plurality of personal identifiable information. The feature extraction module 204 is operatively connected with the feature detection module 202. The feature extraction module 204 is configured to extract the plurality of personal identifiable information features from the group of at least one of a static list and a stream. The static list is obtained in response to scanning the data source. The stream is generated dynamically in response to the scanning of the data source. The preprocessing module 108 is also configured to featurize each group of the personal identifiable information located on the web page after scanning of the data source.

In one embodiment, before any modeling can be applied to the data source, the data source is converted into a computer-readable format. The machine learning module 110 includes the following input and output:

### Input:

1. A group of personal identifiable information: Either as a static list obtained from scanning the data source beforehand or as a stream being generated dynamically as the data source is being scanned.
a. For a Structured data source such as a CSV table, the group of personal identifiable information is the personal identifiable information located in the same row.
b. For a Semi-Structured data source such as a Json file, the group of personal identifiable information is the personal identifiable information located in the same object or as part of a higher-level object of the JSON.
c. For an unstructured data source such as a form or natural text, the group of personal identifiable information is the personal identifiable information located on the same page.
   2. Data source information is also taken as input, the data source information such as file size and the type of the data source.

### Output:

Features that represent the score of the personal identifiable information types, the number of personal identifiable information, and the like. Consider a non-limiting example, a non-limiting list of personal identifiable information features listed below:
a. Number of personal identifiable information
b. Document size
c. The confidence of the personal identifiable information belonging to a single group
d. Number of unique personal identifiable information types
e. 25 percentiles of the confidence of all the personal identifiable information
f. 50 percentiles of the confidence of all the personal identifiable information
g. 75 percentiles of the confidence of all the personal identifiable information
h. Does any personal identifiable information contain a Date of Birth?
i. Does any personal identifiable information contain an email address?
j. Is any personal identifiable information a first name or last name?
k. Is a full name present in the personal identifiable information?
l. Max score of the detection types of all the personal identifiable information. The score of a detection type is determined by its identifiability and uniqueness. For example, a personal identifiable information with social security number (SSN) type has a higher score than a personal identifiable information with a LAST NAME type.
m. Median score of the detection types of all the personal identifiable information
n. Type of the data source, i.e., Structured, Semi-Structured, or Unstructured

For unstructured form data, understanding the context of the personally identifiable information is critical to understanding if PII is present. Therefore, the data source-specific features are considered, such as but not limited to the following below.

a. Visual features for either the entire document, a page, a chunk, or features that vary with location in the chunk.
i. Continuous representation capturing layout, such as where there is whitespace, characters, or personally identifiable information, as built by, for example, an autoencoder.
ii. Simple descriptors such as local text or personally identifiable information density.
iii. How much of the surrounding area is background text, anchor text, or field data.
   b. Text features for either the entire document, page, chunk, or features that vary with location in the chunk.
i. Meaning of the content, such as does it relate more to a particular type of personal identifiable information as given by the personal identifiable information around that region.
ii. Continuous representation capturing a summary of the content, possibly of just in that area or of the entire chunk.
iii. Word vector averaging.
iv. Language modeling, including Bidirectional Encoder Representations from Transformers (BERT) and such built-over indicator functions for word or pertain word vectors.
v. Per token or sentence continuous representations.
vi. Word vectors.
vii. Outputs of different layers of a language model.
viii. Features indicating if the token is also considered personally identifiable information and the type of personally identifiable information.

For the unstructured natural text, a natural language understanding of the document is critical to understand if PII is present. Therefore, the following features are considered:

a. Continuous representation capturing a summary of the content, possibly just in that area or the entire chunk.
i. Word vector averaging
ii. Language modeling, including BERT and such built over indicator functions for word or pertain word vectors.
   b. Per token or sentence continuous representations.
i. Word vectors
ii. Outputs of different layers of a language model
iii. Features indicating if the token is also considered as personally identifiable information and the type of personally identifiable information.
   The classification module 112 takes F generated by a featurizer and predicts if PII is present.
   Considering for a given data source, the featurizer and classifier are applied to all the groups of personally identifiable information:
1. For a Structured data source, every group of personal identifiable information located in the same rows gets featurized and the classifier then predicts if PII is present.
2. For a Semi-Structured data source, every group of personal identifiable information located in the same object gets featurized and the classifier then predicts if PII is present.
3. For an Unstructured data source, all the personal identifiable information found on the same page forms a group of personal identifiable information and gets featurized and the classifier then predicts if PII is present, this is repeated for all the pages.

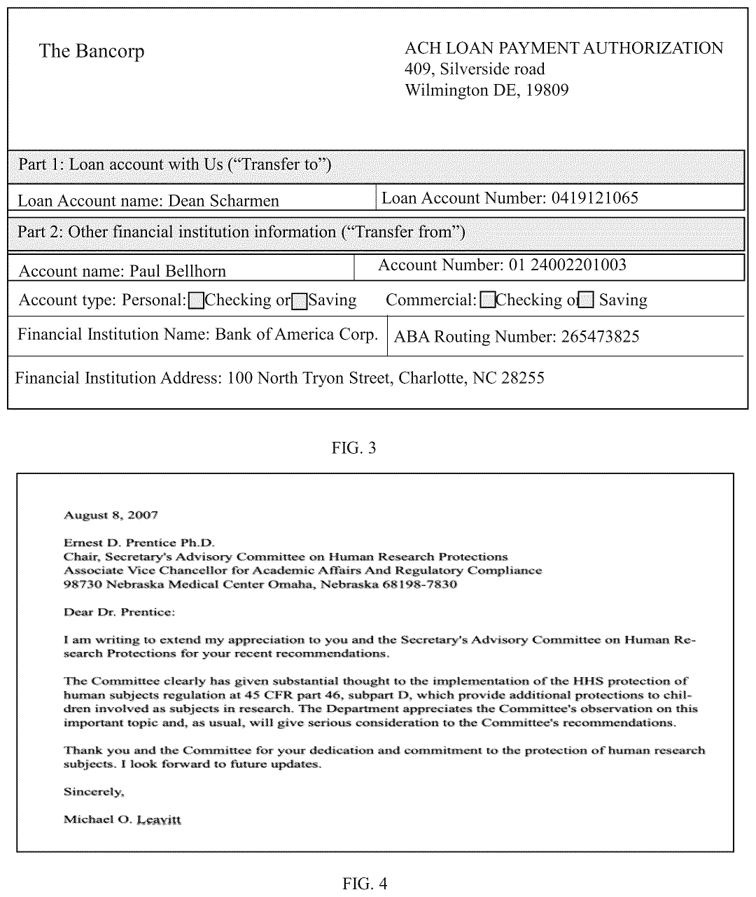

FIG. 3 is an exemplary embodiment of the representation of an unstructured data form of FIG. 1 in accordance with an embodiment of the present disclosure. The unstructured forms have a partially consistent structure. Considering a non-limiting example, when a customer adds more personally identifiable information types, the uniqueness, and identifiability of the personally identifiable information types are provided. The feature extraction module takes the personally identifiable information extracted along with metadata about the data source and converts them into the machine learnable representation. Consider the converted data source as ‘F’. The input of a group of personally identifiable information is taken either as a static list obtained from scanning the data source beforehand or as a stream being generated dynamically as the data source is being scanned. For a structured data source such as a comma-separated values (CSV) table, the group of personally identifiable information is the personally identifiable information located in the same row, for a semi-structured data source such as a Json file. The JSON file stands for JavaScript Object Notation and is an open standard file format and data interchange format that uses human-readable text to store and transmit data objects consisting of attribute-value pairs and arrays. The group of personally identifiable information is the personally identifiable information located in the same object or as part of a higher-level object of the JSON, and for an unstructured data source such as a form or natural text, the group of personally identifiable information is the personally identifiable information located in the same page. For unstructured form data, understanding the context of the personally identifiable information is critical to identify if personally identifiable information (PII) is present. Therefore, the data source-specific features such as but not limited to the following also considered visual or text for either the entire document, page, chunk, or features that vary with location in the chunk, continuous representation capturing layout, such as where there is whitespace, characters, or personally identifiable information, for example, an autoencoder; simple descriptors such as local text or personally identifiable information density. The surrounding area of the personal identifiable information is background text, anchor text, or field data, and for unstructured natural text, having a natural language understanding of the document. The classification module takes ‘F’ extracted by the feature extraction module and predicts if PII is present. For a structured data source, every group of personal identifiable information located in the same rows gets featurized and the classifier then predicts if PII is present. For a semi-structured data source, every group of personal identifiable information located in the same object gets featurized and the classifier then predicts if PII is present. For an unstructured data source, all the PD found on the same page forms a group of personal identifiable information and gets featurized and the classifier then predicts if PII is present, this is repeated for all the pages.

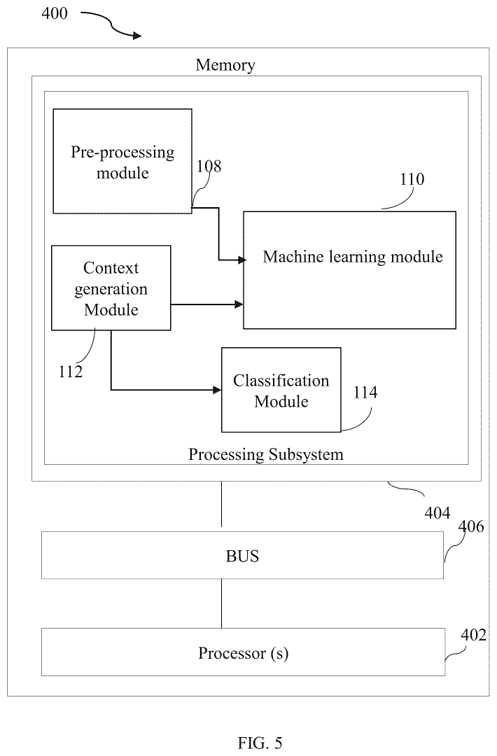

FIG. 4 is an exemplary embodiment of the representation of an unstructured natural text data of data source of FIG. 1 in accordance with an embodiment of the present disclosure. For example, in the unstructured natural text example, the first name personal identifiable information “Michael” has no anchors, however, it is near a middle name personal identifiable information “O.”, and a last name personal data “Leavitt”. The unstructured natural text, may be considered as the following features:

a. Continuous representation capturing a summary of the content, possibly of just in that area or of the entire chunk.
i. Word vector averaging.
ii. Language modeling, including BERT and such built-over indicator functions for word or pertain word vectors.
   b. Per token or sentence continuous representations.
i. Word vectors.
ii. Outputs of different layers of a language model.
iii. Features indicating if the token is also considered personal identifiable information and the type of personal identifiable information.

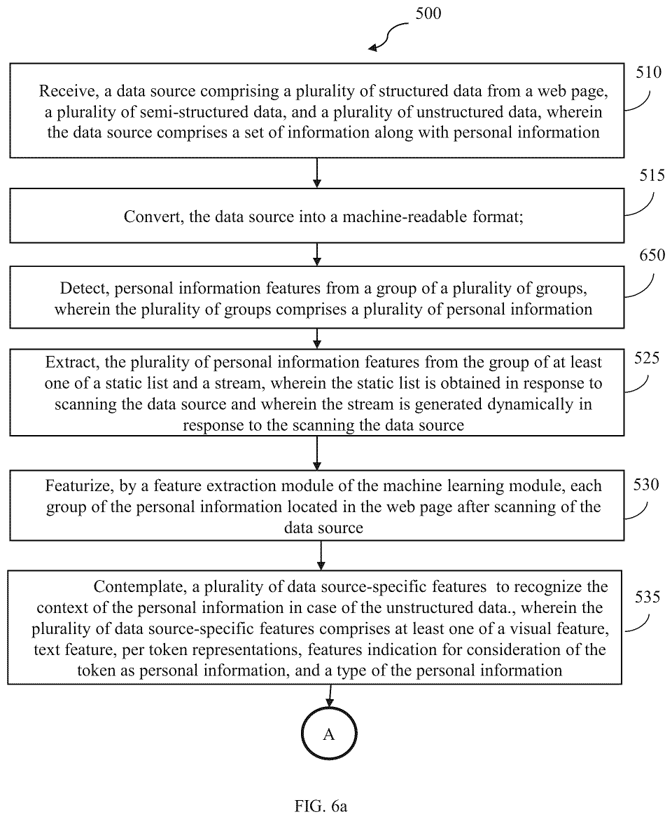

FIG. 5 is a block diagram of a computer or a server 400 in accordance with an embodiment of the present disclosure. The server 400 includes a processor(s) 402, and memory 404 is operatively coupled to the bus 406. The processor(s) 402, as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 404 includes several subsystems stored in the form of computer-readable medium which instructs the processor to perform the method steps illustrated in FIG. 1. The memory 404 is substantially similar to system 100 of FIG. 1. The memory 404 has the following subsystems: includes a pre-processing module 108 and a machine learning module 110. The preprocessing module 108 is configured to receive a data source comprising a plurality of structured data from a web page, a plurality of semi-structured data, and a plurality of unstructured data. The data source includes a set of information with personal identifiable information. The pre-processing module 108 is configured to convert the data source into a machine-readable format. The preprocessing module 108 is configured to receive a data source comprising a plurality of structured data from a web page, a plurality of semi-structured data, and a plurality of unstructured data. The data source includes a set of information with personal identifiable information. The preprocessing module 108 is configured to convert the data source into a machine-readable format.

The bus 406 as used herein refers to be the internal memory channels or computer network that is used to connect computer components and transfer data between them. The bus 406 includes a serial bus or a parallel bus, wherein the serial bus transmits data in bit-serial format and the parallel bus transmits data across multiple wires. The bus 406 as used herein, may include but not limited to, a system bus, an internal bus, an external bus, an expansion bus, a frontside bus, a backside bus, and the like.

While computer-readable medium is shown in an example embodiment to be a single medium, the term “computer-readable medium” should be taken to include a single medium or multiple media (for example, a centralized or distributed database, or associated caches and servers) able to store the instructions. The term “computer-readable-medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

The system includes a processing subsystem 102 hosted on a server 104 and configured to execute on a network 106 to control bidirectional communications among a plurality of modules. The plurality of modules includes a pre-processing module 108 and a machine learning module 110. The preprocessing module 108 is configured to receive a data source including a plurality of structured data from a web page, a plurality of semi-structured data, and a plurality of unstructured data. The data source includes a set of information with personal identifiable information. The preprocessing module 108 is configured to convert the data source into a machine-readable format.

The machine learning module 110 is operatively connected to the preprocessing module. The machine learning module 110. The context recognition module 112 is operatively connected to the machine learning module 110. The context recognition module 112 is configured to contemplate a plurality of data source-specific features to recognize the context of the personal identifiable information in case of the unstructured data. The plurality of data source-specific features includes at least one of a visual feature, text feature, per token representations, features indication for consideration of the token as personal identifiable information, and a type of the personal identifiable information.

The classification module 114 is operatively connected to the machine learning module 110. The classification module is configured to receive the extracted plurality of personal identifiable information features. The classification module 114 is also configured to predict the presence of personally identifiable information in the data source. Further, the classification module 114 is configured to group the personally identifiable information predicted on the web page and predict the presence of the personally identifiable information in an event of the unstructured data source. The grouping is repeated for all the web pages.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 402.

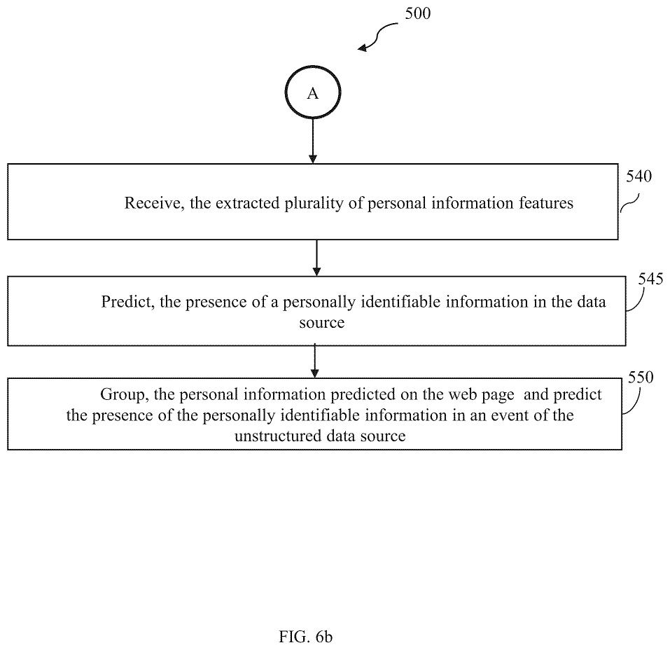

FIG. 6(a) illustrates a flow chart representing the steps involved in a method 500 for the determination and classification of personally identifiable information in a file in accordance with an embodiment of the present disclosure. FIG. 6(b) illustrates continued steps of the method 500 for the determination and classification of personally identifiable information in a file of FIG. 6(a) in accordance with an embodiment of the present disclosure. The method includes providing a score generation module configured to generate a score corresponding to the extracted plurality of personal identifiable information type, wherein the score is generated by the identifiability and uniqueness of the plurality of personal identifiable information.

The method 500 starts at step 510.

At step 510, a data source including a plurality of structured data from a web page, a plurality of semi-structured data, and a plurality of unstructured data is received, wherein the data source includes a set of information along with personally identifiable information. The method also includes representing the data source in a comma-separated values format wherein the group of personally identifiable information is the personally identifiable information located in the same row. The method also includes representing the semi-structured data source as a Javascript object notation file wherein the group of personally identifiable information is the personal identifiable information located in the same object.

At step 515, the unstructured data file is converted into a machine-readable format. The method also includes providing a fixed single machine learning model and prevents the iterative update.

At step 520, personal identifiable information features from a group of a plurality of groups is detected, wherein the plurality of groups includes a plurality of personal identifiable information.

At step 525, the plurality of personally identifiable information features from the group of at least one of a static list and a stream is extracted, wherein the static list is obtained in response to scanning the data source and wherein the stream is generated dynamically in response to the scanning the data source. The method also includes generating the static lists and the stream dynamically as the data source, wherein the data source is scanned along with metadata.

At step 530, each group of the personally identifiable information located on the web page after scanning of the data source is featured. The method also includes classifying the scanned data source.

At step 535, a plurality of data source-specific features to recognize the context of the personally identifiable information in case of the unstructured data is contemplated, wherein the plurality of data source-specific features includes at least one of a visual feature, text feature, per token representations, features indication for consideration of the token as personally identifiable information, and a type of the personally identifiable information. The method also includes providing a continuous representation capturing layout, comprising whitespace, characters, an autoencoder, background text, anchor text, and field data. The method also includes providing a plurality of word vectors, outputs of different layers of language models, and features indicating that the token is considered as the personally identifiable information and the type of personally identifiable information.

FIG. 6b is a flow chart representing steps of method 500 for the determination and classification of personally identifiable information using a machine learning model in accordance with an embodiment of the present disclosure.

At step 540, the extracted plurality of personally identifiable information features is received. The method also includes resulting, in an output of the system is the plurality of features representing the score of the personal identifiable information types, the number of personal identifiable information groups comprising a document size, a number of unique personal identifiable information types, and the type of the data source. The method also includes featuring every group of the personal identifiable information located in the same row and the classification module predicts the presence of the personally identifiable information in the structured data source.

At step 545, the presence of personally identifiable information in the data source is predicted. The method also includes providing a personal identifiability score wherein the personally identifiable score includes a fixed value and is pre-determined, based on the detected feature type. The method also includes pre-determining, an identifiability score for calculating the personally identifiable information.

At step 550, the personally identifiable information predicted on the web page and predict the presence of the personally identifiable information in an event of the unstructured data source is grouped.

Various embodiments of the system and the method for determination and classification of the personally identifiable information in a file described above, enable various advantages. The system in the present disclosure detects the personally identifiable information (PII) in a document. The system in the present disclosure is able to sift through large corpuses of documents and identifies the documents containing personally identifiable information. The system allows processing of large files automatically. The system provides accuracy at the PII classification level by using machine learning algorithms. The system avoids adding rules for PII detection system. The system provides the uniqueness and identifiability of the personal identifiable information. The system provides automated PII detection to reduce manual efforts.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for determination and classification of personally identifiable information in a file using machine learning, wherein the system comprises:
a processing subsystem hosted on a server, and configured to execute on a network to control bidirectional communications among a plurality of modules comprising:
a preprocessing module configured to:
receive a data source comprising a plurality of structured data from a web page, a plurality of semi-structured data, and a plurality of unstructured data, wherein the data source comprises a set of information with a personal identifiable information; and
convert the data source into a machine-readable format;
a machine learning module operatively connected to the preprocessing module wherein the machine learning module comprises:
a feature detection module configured to detect personally identifiable information features from a group of a plurality of groups, wherein the plurality of groups comprises a plurality of personally identifiable information;
a feature extraction module operatively connected with the feature detection module and configured to:
extract the plurality of personal identifiable information features from the group of at least one of a static list and a stream, wherein the static list is obtained in response to scanning the data source and wherein the stream is generated dynamically in response to the scanning the data source; and
featurize each group of the personal identifiable information located in the web page after scanning of the data source;
a context recognition module operatively connected to the machine learning module and configured to:
contemplate a plurality of data source-specific features to recognize the context of the personal identifiable information in case of the unstructured data., wherein the plurality of data source-specific features comprises at least one of a visual feature, text feature, per token representations, features indication for consideration of the token as personally identifiable information, and a type of the personally identifiable information; and
a classification module operatively connected to the feature extraction module, wherein the classification module is configured to:
receive the extracted plurality of personally identifiable information features; and
predict the presence of personally identifiable information in the data source; and
group the personally identifiable information predicted on the web page and predict the presence of the personally identifiable information in an event of the unstructured data source, wherein the grouping is repeated for all the web pages.

2. The system according to claim 1, wherein the structured data source is represented in a comma-separated values format wherein the group of personally identifiable information is the personally identifiable information located in the same row.

3. The system according to claim 1, wherein the semi-structured data source is a Javascript object notation file wherein the group of personal identifiable information is the personal identifiable information located in the same object.

4. The system according to claim 1, wherein the unstructured data source is represented as at least one of a form or a natural text wherein the group of personally identifiable information is the personally identifiable information located on the same web page.

5. The system according to claim 1, wherein at least one of the static lists and the stream is generated dynamically as the data source, wherein the data source is scanned along with metadata.

6. The system according to claim 1, comprises a score generation module configured to generate a score corresponding to the extracted plurality of personal identifiable information type, wherein the score is generated by the identifiability and uniqueness of the plurality of personal identifiable information.

7. The system, according to claim 1, wherein the machine learning module comprises a fixed single machine learning model and prevents the iterative update.

8. The system according to claim 1, wherein the text data source-features comprises simple descriptors such as local text, personal identifiable information density, the meaning of the content, language modelling, and bi-directional encoder representation from transformation.

9. The system according to claim 1, wherein the visual feature comprises a continuous representation capturing layout, comprising whitespace, characters, an autoencoder, background text, anchor text, and field data.

10. The system according to claim 1, wherein the per token comprises a plurality of word vectors, outputs of different layers of language models, and features indicating that the token is considered as the personal identifiable information and the type of personal identifiable information.

11. The system according to claim 1, wherein an output of the system is the plurality of features representing the score of the personal identifiable information types, the number of personal identifiable information groups comprising a document size, a number of unique personal identifiable information types, and the type of the data source.

12. The system according to claim 1, wherein the classification module is configured to feature every group of the personal identifiable information located in the same row and the classification module predicts the presence of the personally identifiable information in the structured data source.

13. The system according to claim 1, comprises a personal identifiability score wherein the personally identifiable score comprises a fixed value and is pre-determined, based on the detected feature type.

14. A method for determining and classifying personal identifiable information in a file, the method comprises:
receiving, by a preprocessing module of a processing subsystem, a data source comprising a plurality of structured data from a web page, a plurality of semi-structured data, and a plurality of unstructured data, wherein the data source comprises a set of information along with personal identifiable information;
converting, by the preprocessing module of the processing subsystem, the data source into a machine-readable format;
detecting, by a future detection module of a machine learning module, personal identifiable information features from a group of a plurality of groups, wherein the plurality of groups comprises a plurality of personal identifiable information;
extracting, by a feature extraction module of the machine learning module, the plurality of personal identifiable information features from the group of at least one of a static list and a stream, wherein the static list is obtained in response to scanning the data source and wherein the stream is generated dynamically in response to the scanning the data source;
featurizing, by a feature extraction module of the machine learning module, each group of the personal identifiable information located in the web page after scanning of the data source;
contemplating, by a context recognition module of the processing subsystem, a plurality of data source-specific features to recognize the context of the personal identifiable information in case of the unstructured data., wherein the plurality of data source-specific features comprises at least one of a visual feature, text feature, per token representations, features indication for consideration of the token as personal identifiable information, and a type of the personal identifiable information;
receiving, by a classification module of the processing subsystem, the extracted plurality of personal identifiable information features;
predicting, by the classification module of the processing subsystem, the presence of a personally identifiable information in the data source; and
grouping, by the classification module of the processing subsystem, the personal identifiable information predicted on the web page and predict the presence of the personally identifiable information in an event of the unstructured data source.

15. The method according to claim 14, comprises pre-determining, an identifiability score for calculating the personally identifiable information.

16. The method according to claim 14, comprises classifying, by the machine learning module, the scanned data source.

17. A non-transitory computer-readable medium storing a computer program that, when executed by a processor, causes the processor to perform a method for the determination and classification of personal identifiable information in a file, wherein the method comprises:
receiving, by a preprocessing module of a processing subsystem, a data source comprising a plurality of structured data from a web page, a plurality of semi-structured data, and a plurality of unstructured data, wherein the data source comprises a set of information with a personal identifiable information;
converting, by the preprocessing module of the processing subsystem, the data source into a machine-readable format;
detecting, by a future detection module of a machine learning module, personal identifiable information features from a plurality of groups, wherein the plurality of groups comprises a plurality of personal identifiable information;
extracting, by a feature extraction module of the machine learning module, the plurality of personal identifiable information features from the group of at least one of a static list and a stream, wherein the static list is obtained in response to scanning the data source and wherein the stream is generated dynamically in response to the scanning the data source;
featurizing, by a feature extraction module of the machine learning module, each group of the personal identifiable information located in the web page after scanning of the data source;
contemplating, by a context recognition module of the processing subsystem, a plurality of data source-specific features to recognize the context of the personal identifiable information in case of the unstructured data., wherein the plurality of data source-specific features comprises at least one of a visual feature, text feature, per token representations, features indication for consideration of the token as personal identifiable information, and a type of the personal identifiable information;
receiving, by a classification module of the processing subsystem, the extracted plurality of personal identifiable information features;
predicting, by the classification module of the processing subsystem, the presence of a personally identifiable information in the data source; and
grouping, by the classification module of the processing subsystem, the personal identifiable information predicted on the web page and predicting the presence of the personally identifiable information in an event of the unstructured data source.
